(19) United States
(12) Patent Application Publication
(10) Pub. No.: US 2025/0074744 A1
(43) Pub. Date: Mar. 6, 2025

(54) AN ELEVATOR AND A METHOD FOR PROVIDING ACCESS TO AN ELECTRICAL SAFETY DEVICE OF AN ELEVATOR

(71) Applicant: KONE Corporation, Helsinki (FI)

(72) Inventors: Ari Jussila, Helsinki (FI); Toni Hirvonen, Helsinki (FI); Matti Leino, Helsinki (FI)

(73) Assignee: KONE Corporation, Helsinki (FI)

(21) Appl. No.: 18/788,963

(22) Filed: Jul. 30, 2024

(30) Foreign Application Priority Data
Sep. 5, 2023 (EP) 23195409.0

(51) Int. Cl. B66B 5/00; B66B 3/00

(52) U.S. Cl. CPC B66B 5/0031; B66B 3/002; B66B 5/0087

(57) ABSTRACT

An elevator includes an elevator car inside an elevator shaft, adapted to transfer passengers and/or cargo between landings; an electric drive for operating the elevator car; a manual operating panel disposed inside the elevator shaft for manual drive of the elevator car; and an elevator safety chain including a controller in connection with a plurality of safety devices for monitoring elevator safety. The safety chain includes an electrical safety device configured to provide information about the elevator car approaching a temporary refuge space inside the shaft. The controller is configured to obtain information from the electrical safety device, and to generate a stopping command to stop movement of the elevator car before entering the refuge space. The controller is configured to, in response to a maintenance request of the electrical safety device, exclude the electrical safety device from operation of the elevator safety chain, to enable manual drive of the elevator car with the manual operating panel. A method provides access to an electrical safety device of an elevator.

### FIELD OF THE INVENTION

The invention relates to an elevator for transferring passengers and/or cargo between landings inside an elevator shaft and a method for providing access to an electrical safety device of an elevator.

### BACKGROUND OF THE INVENTION

In addition to a normal operating mode, an elevator may have a manual drive operating mode. The manual drive operating mode is useful, for example, in connection with inspection and/or maintenance operations of an elevator system. In the manual drive operating mode a normal operation is prevented, and an elevator car may be driven manually only with reduced speed, for example, 0.3 m/s. The manual drive operating mode may be carried out by continuously activating an input means, such as a push button or a switch in a manual operating panel. When the input means in the manual operating panel is deactivated, the movement of the elevator car stops. This means that in the manual drive operating mode the elevator car is moving only when the input means is maintained activated. The manual operating panel may be arranged in the elevator shaft pit or on a roof of the elevator car.

The elevator may have a safety chain configured for controlling elevator safety during the maintenance and inspection operations. To improve elevator safety, a temporary refuge space may be arranged for service personnel working in the shaft. The elevator safety chain may comprise an electrical safety device fitted in the shaft to provide information about the elevator car approaching the temporary refuge space in the manual drive operating mode. Such an electrical safety device may be a limit switch setting a limit for movement of the car towards the temporary refuge space. The limit switch interrupts the elevator safety chain when the car arrives at the switch in the manual drive operating mode. This will cause activation of hoisting machinery brakes and interrupting power supply to the hoisting motor. Consequently the elevator car movement will stop before the car enters the refuge space.

An operational anomaly, e.g. a failure or an installation error, of the limit switch may disable the manual drive operation, to ensure that the service personnel located in the shaft cannot move the car into the temporary refuge space. In that case moving of the car would be possible from outside of the shaft only, e.g. by manually opening the hoisting machinery brakes or using a rescue drive switch in an elevator control cabinet for rescue operation. The rescue drive switch bypasses the safety chain to enable low-speed rescue operation of the car.

To fix said operational anomaly, the service technician must however gain access to the limit switch. In many cases, this is only possible by working from the roof of the elevator car positioned below the limit switch, in the immediate vicinity of the switch. This all means that fixing the limit switch can be difficult, as in practice two service technicians are required for the work, one operating the rescue drive switch in the control cabinet to move the car to a suitable working location, while the other one enters the shaft and stands on the roof of the moving car. Further, bypassing the safety chain can also be an additional safety risk for the service technician in the shaft.

### SUMMARY OF THE INVENTION

The objective of the invention is to solve at least one of the above-identified problems. The invention brings forward an elevator having a new kind of maintenance operating function providing safe and easy access for a service technician to an electrical safety device inside an elevator shaft.

It is brought forward a new elevator according to claim 1.

It is also brought forward a new method according to claim 15.

Further embodiments of the invention are described in the dependent claims and the following description.

The elevator comprises an elevator car adapted for transferring passengers and/or cargo between landings inside an elevator shaft and an electric drive for operating the elevator car. The elevator may also comprise a counterweight moving in an opposite direction than the elevator car, as is known in the art. According to an embodiment the electric drive comprises an elevator hoisting machinery and an elevator drive unit. According to an embodiment the elevator hoisting machinery comprises an elevator hoisting motor, such as a permanent magnet motor, and a traction sheave for hoisting ropes of the car/counterweight. According to an embodiment, the elevator drive unit comprises a frequency converter providing power signals to the elevator hoisting motor.

Further, the elevator comprises a manual operating panel disposed inside the elevator shaft and used to manually drive the elevator car. The manual operating panel comprises input means, such as a push button and/or a switch. Low-speed manual drive may be carried out by continuously activating the input means. When the input means in the manual operating panel are deactivated, the movement of the elevator car stops. This means that in the manual drive operating mode the elevator car is moving only when the input means are maintained activated. The manual operating panel may be arranged, for example, in an elevator shaft pit or on the roof of the elevator car.

The elevator also comprises an elevator safety chain. The safety chain comprises a controller in connection with plurality of safety devices, such as safety contacts, for monitoring elevator safety during the maintenance and inspection operations.

The elevator safety chain comprises an electrical safety device configured for providing information about the elevator car approaching a temporary refuge space inside the shaft. According to an embodiment the electrical safety device is configured to set a limit for movement of the car towards the temporary refuge space, e.g. a limit switch. According to an embodiment the limit switch opens and interrupts the safety chain when the car arrives at the limit switch in the manual drive operating mode. This will cause stopping of car movement before entering the refuge space.

Further, the controller is configured to obtain information from the electrical safety device, and to generate a stopping command, e.g. to hoisting machinery brakes, to stop movement of the car and interrupt the low-speed manual drive before entering the refuge space. According to an embodiment the controller is an electronic safety controller running a safety software. According to an embodiment the electronic safety controller is designed to comply with safety norm IEC61508 and to fulfil safety integrity level 3 (SIL 3) of said norm.

In response to a maintenance request of the electrical safety device, the controller is configured to exclude the electrical safety device from operation of the elevator safety chain, to allow manual drive of the car with the manual operating panel.

In case an operational anomaly, e.g. a fault or an installation error, of the electrical safety device prevents the manual drive of the car in the elevator shaft with the manual operating panel, the service technician may generate a specific maintenance request for repairing said electrical safety device. According to an embodiment, said maintenance request is generated via a manual input panel, a mobile device, or it is received from a remote location, such as from a service centre.

According to an embodiment, in response to said maintenance request, the controller bypasses, e.g., in its software, a portion of the elevator safety chain including the electrical safety device. In that way only said safety chain portion may be bypassed, and said bypass therefore doesn't affect operation of rest of the safety chain. This means that manual drive of the car with the manual operating panel is possible under the control of the (still functional portion of the) safety chain.

Consequently, said safety chain (with said bypass) allows manual drive of the car by the service technician standing on the car roof to a position, where the service technician can access the electrical safety device from the elevator car roof, i.e. providing safe and easy access for the service technician to the electrical safety device for fixing the electrical safety device on his own.

### BRIEF DESCRIPTION OF THE DRAWINGS

The invention will in the following be described in greater detail by means of preferred embodiments with reference to the attached drawings, in which:

FIG. 1 shows an elevator,

FIG. 2 shows a block diagram of some elements of the elevator,

FIG. 3 shows a prior art example of fixing a limit switch of an elevator, and

FIG. 4 shows an example of providing access to an electrical safety device.

### DETAILED DESCRIPTION

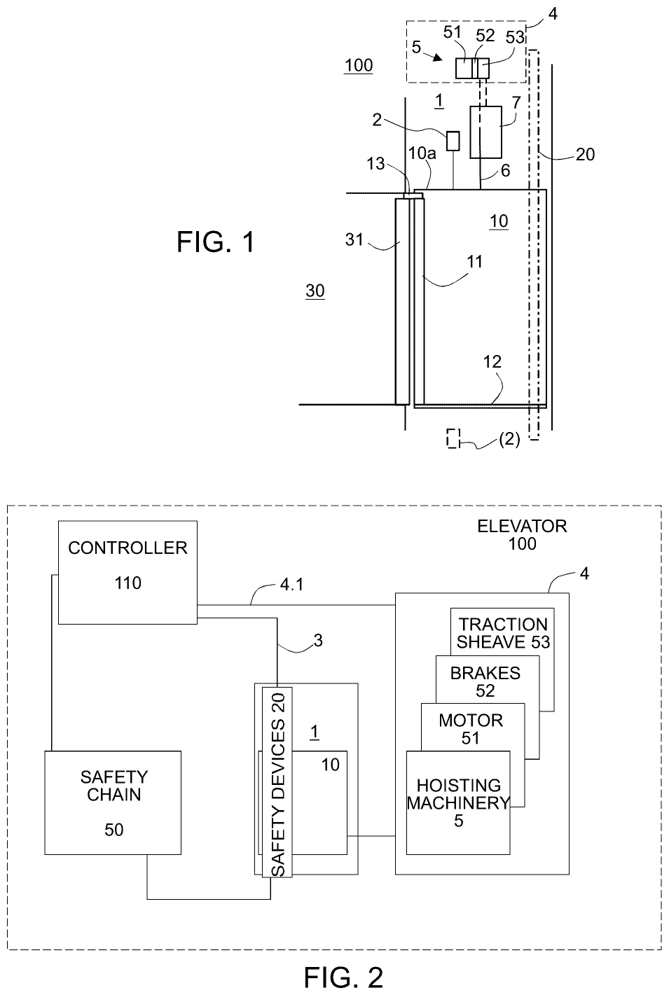

FIG. 1 schematically illustrates some aspects of an exemplary elevator 100 comprising an elevator car 10 and an electric drive 4 operable to drive the car 10 in an elevator shaft 1, to transfer passengers and/or cargo between landings 30. The electric drive 4 in FIG. 1 comprises an elevator hoisting machinery 5 and an elevator drive unit. The hoisting machinery 5 comprises an elevator hoisting motor 51 such as a permanent magnet motor for driving the car 10, as well as hoisting machinery brakes 52 configured to apply to a traction sheave 53 or a rotating axis of the hoisting machinery, to stop movement of the car or hold the car standstill at a landing 30 in the shaft 1.

The elevator in FIG. 1 has hoisting ropes 6 supporting the car 10, running via the traction sheave 53, and connected to a counterweight 7.

The elevator 100 in FIGS. 1 and 2 comprises an elevator controller 110 configured to control elevator operation in normal and manual operation modes. The elevator 100 comprises an electric drive 4 for operating the elevator car 10, and a manual operating panel 2 disposed inside the elevator shaft for manual drive of the elevator car. The manual operating panel may be arranged, for example, in an elevator shaft pit 1b or on the roof 10a of the elevator car.

The elevator 100 comprises a safety chain 50 comprising plurality of safety devices 20; 21 for controlling elevator safety.

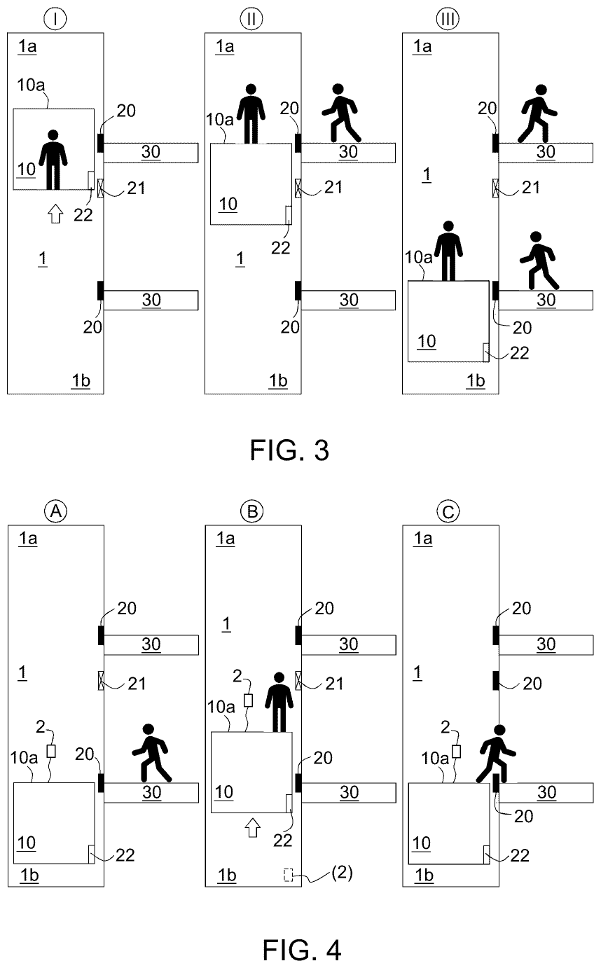

The safety chain 50 comprises an electrical safety device 20; 21, e.g. a limit switch, configured to provide information about the elevator car 10 approaching a temporary refuge space 1a; 1b inside the shaft 1. The temporary refuge space 1a; 1b may be established proximate to a shaft end, as shown in FIGS. 3 and 4. According to an embodiment, instead of a mechanical switch the electrical safety device may be e.g. a camera or a non-contact proximity switch.

The safety chain 50 further comprises a controller 110 configured to obtain information from the electrical safety device, and to generate a stopping command 4.1 to stop movement of the car 10 before entering the refuge space 1a; 1b.

In response to a maintenance request 3 of the electrical safety device 20; 21, the controller 110 excludes the electrical safety device 20; 21 from operation of the safety chain 50, for example, by bypassing in the software a portion of the safety chain 50 including the electrical safety device, to allow manual drive of the car with the manual operating panel 2.

The car 10 is provided with a car door 11 and a car floor 12. The car door 11 comprises a door that may be moved between a closed position and an open position. The car door 11 may be kept locked while the car 10 is moving, unlocked upon the car 10 entering a landing zone located at and close to a landing 30 and opened upon the car 10 stopping at the landing 30. The car door 11 may be closed before the car 10 leaves the landing 30 and locked upon the car 10 exiting the landing zone. The car 10 is provided with a door operator 13 connected to the car door 11 for temporarily coupling the car door 11 to a landing door 31 provided at each landing 30 when the car 10 resides within the landing zone of the landing 30 such that the landing door 31 moves between a closed position and an open position together with the car door 11, thereby allowing passengers to move between the landing 30 and the car 10 when the car 10 is at the landing 30 while preventing the passengers from entering the shaft 1 when the elevator car 10 is not at the landing 30.

FIG. 2 shows an exemplary block diagram of some elements of the elevator 100.

According to an embodiment, the elevator 100 comprises means for determining operating condition of the electrical safety device 20; 21 and means for generating a signal indicating an operational anomaly of the electrical safety device.

According to an embodiment, the controller 100 is configured to bypass a portion of the safety chain 50 including the electrical safety device 20; 21, to allow manual drive of the car 10 to a position, where a service technician can access the electrical safety device from elevator car roof 10a.

According to an embodiment, the elevator 100 further comprises a mechanical safety device configured to protect the temporary refuge space 1a; 1b inside the elevator shaft 1. According to an embodiment, the mechanical safety device comprises a buffer in the temporary refuge space and/or a balustrade on the car roof 10a.

According to an embodiment, the controller 110 is configured to bypass the portion of the safety chain 50 including the electrical safety device 20; 21, to allow manual drive of the car under control of rest of the elevator safety chain. According to an embodiment, the controller 110 is an electronic safety controller configured to run a safety software. According to an embodiment, the controller 110 is configured to generate a stopping command 4.1 to hoisting machinery brakes 52.

According to an embodiment, the electrical safety device is a limit switch 20; 21 which is configured to open and interrupt the safety chain 50 when the car 10 arrives at the limit switch in the manual drive operating mode. According to an embodiment, the electrical safety device is a camera or a non-contact proximity switch.

According to an embodiment, the electrical safety device is configured to set a limit for movement of the car towards the temporary refuge space 1a; 1b which preferably is established proximate to a shaft end.

FIG. 3 shows a prior art example of fixing a failed limit switch of an elevator.

In phase I, a top inspection limit switch 21 has incorrect polarity, in other words, there has been a malfunction of that electrical safety device 21. The elevator car 10 passes the limit switch 21 during normal operating mode and due to the wrong polarity said limit 21 is detected failed because it is not active during cooperation with its counterpart 22 in the car 10 at the top landing 30.

In phase II, service technicians come to the site to do maintenance for the elevator. They enter the shaft 1 and try to run top of car inspection but it is prevented because of the failed limit switch 21. They cannot fix the issue with the limit switch because the car 10 is blocking the access.

In phase III, one service technician leaves the shaft 1 to a manual operating panel or a machine room to lower the elevator in rescue drive mode to a better position in order to fix the issue with the failed limit switch 21. The other service technician stays on the car roof 10a during manually lowering the car. Bypass jumpers in a maintenance user interface are required to be used to bypass the faulty input. Usage of bypass inputs bypasses also other safety devices and contacts. To gain access to the faulty limit switch 21 the car 10 needs to be stopped to such position where the repair work can be done. Because this is not typically landing 30 level, several attempts might be required. If the car does not stop to feasible position, this needs to be repeated. The position where the service technician can access the car roof 10a is not necessarily the optimal position for fixing the issue with the failed limit switch 21 and therefore a ladder or similar assistance is required.

FIG. 4 shows an example of providing access to an electrical safety device 21. The example shows how a failed electrical safety device 21 can be fixed safely by a single service technician.

In phase A, a top inspection limit switch 21 has incorrect polarity, in other words, there has been a malfunction of that electrical safety device 21. One service technician drives the car 10 to a lower landing 30 which is closest to the failed inspection limit switch 21. The door at the lower landing 30 is left open. The service technician secures the area and uses the manual operating panel 2 disposed inside the elevator shaft on the car roof 10a for manual drive of the elevator car.

In phase B, the service technician drives the car manually upwards to a position, where the service technician can access the failed limit switch 21 from the car roof 10a.

In phase C, once the failed limit switch 21 has been fixed and the operation of the corresponding limit switch 20 has been verified, the service technician runs the elevator downwards to landing 30 level. The service technician deactivates the input means on the manual operating panel 2, such as a push button and/or a switch, to end the manual drive operating mode and leaves the shaft 1.

A method for providing access to an electrical safety device 20; 21 of an elevator 100 comprises obtaining by the controller 110 information provided by the electrical safety device about the elevator car 10 approaching the temporary refuge space 1a; 1b inside the shaft 1. Further the method comprises generating by the controller a stopping command 4.1 to stop movement of the elevator car before entering the refuge space; and in response to a maintenance request 3 of the electrical safety device, excluding, by the controller, the electrical safety device from operation of the elevator safety chain 50, to allow manual drive of the elevator car with the manual operating panel 2; and driving, by means of the manual operation panel 2, elevator car 10 to a position, where the electrical safety device is accessible from the elevator car roof.

The use of the invention is not limited to the embodiments disclosed in the figures. It will be obvious to a person skilled in the art that, as the technology advances, the inventive concept can be implemented in various ways. The invention and its embodiments are not limited to the examples described above but may vary within the scope of the claims.

1. An elevator, comprising:
an elevator car inside an elevator shaft, adapted to transfer passengers and/or cargo between landings;
an electric drive for operating the elevator car;
a manual operating panel disposed inside the elevator shaft for manual drive of the elevator car; and
an elevator safety chain comprising a controller in connection with a plurality of safety devices for monitoring elevator safety,
wherein the safety chain comprises an electrical safety device configured to provide information about the elevator car approaching a temporary refuge space inside the elevator shaft,
wherein the controller is configured to obtain information from the electrical safety device, and to generate a stopping command to stop movement of the elevator car before entering the refuge space, and
wherein the controller is configured to, in response to a maintenance request of the electrical safety device, exclude the electrical safety device from operation of the elevator safety chain, to enable manual drive of the elevator car with the manual operating panel.

2. The elevator according claim 1, wherein the elevator comprises means for determining an operating condition of the electrical safety device and means for generating a signal indicating an operational anomaly of the electrical safety device.

3. The elevator according to claim 1, wherein the controller is configured to bypass a portion of the elevator safety chain including the electrical safety device, to allow manual drive of the car to a position, where a service technician can access the electrical safety device from an elevator car roof.

4. The elevator according to claim 1, wherein the elevator further comprises a mechanical safety device configured to protect the temporary refuge space inside the elevator shaft.

5. The elevator according to claim 1, wherein the controller is configured to bypass a portion of the elevator safety chain including the electrical safety device, to allow manual drive of the elevator car under control of a remainder of the elevator safety chain.

6. The elevator according to claim 1, wherein the controller is an electronic safety controller configured to run a safety software.

7. The elevator according to claim 1, wherein the electrical safety device is a limit switch.

8. The elevator according to claim 7, wherein the limit switch is configured to open and interrupt the elevator safety chain when the car arrives at the limit switch in manual drive operating mode.

9. The elevator according to claim 1, wherein the electrical safety device is a camera or a non-contact proximity switch.

10. The elevator according to claim 1, wherein the electrical safety device is configured to set a limit for movement of the car towards the temporary refuge space.

11. The elevator according to claim 1, wherein the temporary refuge space is established proximate to a shaft end.

12. The elevator according to claim 1, wherein the electric drive comprises an elevator hoisting machinery and an elevator drive unit.

13. The elevator according to claim 12, wherein the controller is configured to generate a stopping command to hoisting machinery brakes.

14. The elevator according to claim 12, wherein the elevator hoisting machinery comprises;
an elevator hoisting motor; and
a traction sheave for hoisting ropes of the elevator car and an elevator counterweight.

15. A method for providing access to the electrical safety device of the elevator according to claim 1, comprising the steps of:
obtaining, by the controller, information provided by the electrical safety device about the elevator car approaching the temporary refuge space inside the elevator shaft; and
generating, by the controller, a stopping command to stop movement of the elevator car before entering the refuge space; and
in response to a maintenance request of the electrical safety device, excluding, by the controller, the electrical safety device from operation of the elevator safety chain, to allow manual drive of the elevator car with the manual operating panel; and
driving, by means of the manual operation panel, the elevator car to a position, where the electrical safety device is accessible from an elevator car roof.

16. The elevator according to claim 2, wherein the controller is configured to bypass a portion of the elevator safety chain including the electrical safety device, to allow manual drive of the car to a position, where a service technician can access the electrical safety device from an elevator car roof.

17. The elevator according to claim 2, wherein the elevator further comprises a mechanical safety device configured to protect the temporary refuge space inside the elevator shaft.

18. The elevator according to claim 3, wherein the elevator further comprises a mechanical safety device configured to protect the temporary refuge space inside the elevator shaft.

19. The elevator according to claim 2, wherein the controller is configured to bypass a portion of the elevator safety chain including the electrical safety device, to allow manual drive of the car under control of a remainder of the elevator safety chain.

20. The elevator according to claim 3, wherein the controller is configured to bypass a portion of the elevator safety chain including the electrical safety device, to allow manual drive of the car under control of a remainder of the elevator safety chain.
